(19) United States
(12) Patent Application Publication
(10) Pub. No.: US 2005/0286719 A1
(43) Pub. Date: Dec. 29, 2005

(54) Generating entropy through image capture

(75) Inventor: Devon Kemp, Laguna Hills, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/878,574

(22) Filed: Jun. 29, 2004

(51) Int. Cl. H04N 7/167

(52) U.S. Cl. 380/200

(57) ABSTRACT

Cryptographically securing second image data using a cryptographic value derived from entropy generated by capture of first image data different from the second image data and obtained by the same image capture device. With the foregoing, an image capture device, which may be networked, is able to obtain a more random and better source of entropy, which results in a stronger cryptographic value for the securing of image data.

### BACKGROUND OF THE INVENTION

1. Field of the Invention

The present invention relates to the generation of entropy through capture of a first image with an image capture device, such as a flat bed scanner, so as to cryptographically secure a second image captured with the same image capture device.

2. Description of the Related Art

When information or data is sent from one device to another device, the information sometimes passes through a public network, such as the Internet. The information may pass through many computers, routers, switches and other devices before it reaches its destination. Along the way, there are many opportunities for an unintended party to intercept the information, and possibly modify it, before it reaches its intended destination. Accordingly, much attention has focused on the development of secure methods of transmitting information from one device to another across a network.

In this context, a “secure method” generally refers to any one (or more) of at least three different aspects of secure transmission: confidentiality, which means that even if intercepted, the transmission cannot be read by an unauthorized user; authentication, which means that the recipient can determine with certainty that the transmission originated from where it appears to have originated; and integrity, which means that the recipient can be certain that even if the transmission was intercepted, it has not been modified.

Typical methods for secure transmission include encryption systems utilizing cryptographic keys or values, such as for encryption, to ensure confidentiality, or for digital signatures to ensure authentication and integrity. However, if the cryptographic value or key is determined or known, an interceptor might be able to read the contents of the encrypted data, modify it, or forge a new transmission from an apparently trustworthy source. In this regard, the strength of a key is based on its predictability or ease with which it may be determined. A more random or unpredictable number makes it more difficult for an interceptor to determine the key. Likewise, the stronger the key, the less likely an interceptor will be able to determine its value.

To generate a more random number or key, some network devices, such as networked image capture devices, generate random data or entropy for a cryptographic value or number to be used as the key. However, networked image capture devices have very few effective sources of random data because they are generally simple by nature and contain few parts (especially moving parts). Accordingly, these networked image capture devices are weak providers of entropy.

One source of entropy for such networked image capture devices is network data from a network connection. Many consider this source to be a poor source of entropy because outsiders, including potential interceptors, can easily view such data. With the network data in hand, an interceptor could use that data to recreate the random number used as the key.

Accordingly, current sources of entropy for image capture devices are inadequate.

### SUMMARY OF THE INVENTION

The present invention addresses the foregoing by generating entropy through the capture of a first image with an image capture device so as to cryptographically secure a second image captured with the same image capture device. In this manner, the present invention provides a better source of entropy since the first image may be captured from many different objects, thereby generating unpredictable data.

Thus, in one aspect, the invention involves capturing different first and second image data with the same image capture device, generating entropy from the first image data, deriving a cryptographic value from the generated entropy, and cryptographically securing the second image data with the cryptographic value.

The present invention is not limited to any particular type of image capture device, and the image capture device may be a scanning device, such as a flat bed scanner, or a digital camera.

The first image data and second image data may be acquired in separate captures or in the same capture. For example, in the instance of the capture of first and second image data through scanning, a first object may be scanned to obtain the first image data and a second object that is different from the first object may be scanned to obtain the second image data that is different from the first image data. Also, the first and second image data can be first and second scannings of the same object, which is moved between scannings, resulting in first image data that is different from the second image data. Alternatively, one or more objects may be scanned together in a single scan so long as the first image data is derived from an object or objects that are different from the object or objects from which the second image data is derived. For example, an object may be scanned once, but the first image data is derived from only one portion of the object and the second image data is derived from a different portion of the same object. In another illustrative example, two objects may be scanned together in the same scan, with the first image data derived from one object and the second image data derived from the second object.

The objects on which the first image data is based may be any article or thing so long as image data may be captured from it. For example, suitable objects for image capture include a print medium with text/graphics, a body part (e.g., a hand), a photographic picture, or (in the case of image capture with a digital camera) a natural scene.

In a preferred aspect, the present invention further comprises a network connection for transferring the secured second image data to another device, such as a computer, router, or switch.

In another preferred aspect, the generated entropy derived from a captured first image data may be combined with a separate entropy to create a cryptographic value for use in securing a second image data. For example, the separate entropy may be any entropy generated from the image capture device other than entropy derived from the captured first or second image data. Such entropy could be entropy generated from the random positioning of a scanning head. By way of another example, the separate entropy also may be derived from network connection data from the network connection. Such network connection data includes information packet contents, rates of information packet transfer, and times between information packet transfers.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 depicts one embodiment of an image input device of the present invention.

FIG. 2 provides an overview of the image input device of the present invention.

FIG. 3 depicts a process for capture of a first image with an image capture device so as to cryptographically secure a second image captured with the same image capture device.

FIG. 4 depicts a process of transferring a secured second image data.

### DETAILED DESCRIPTION OF THE INVENTION

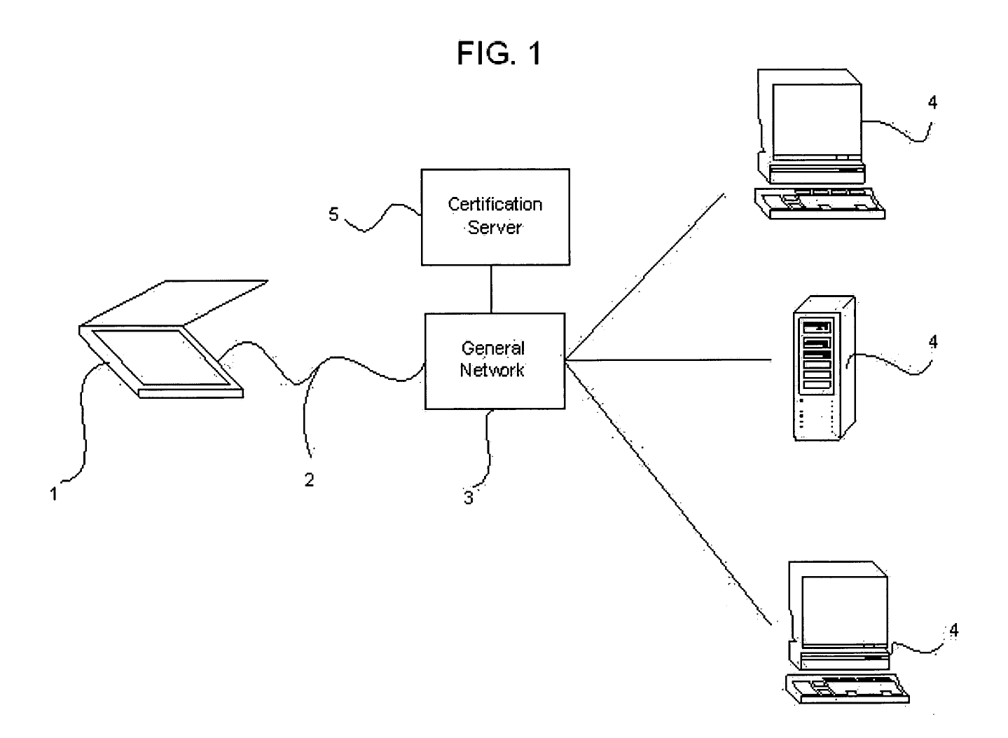

FIG. 1 shows an image input device in the form of a flatbed scanner 1 connected to a network 3 through a network connection 2. With a network connection 2, it is possible to transfer image data through network 3, such as the Internet, to another device 4, such as workstations and computer servers. A certification server 5 may also be connected to the network 3, for purposes described below.

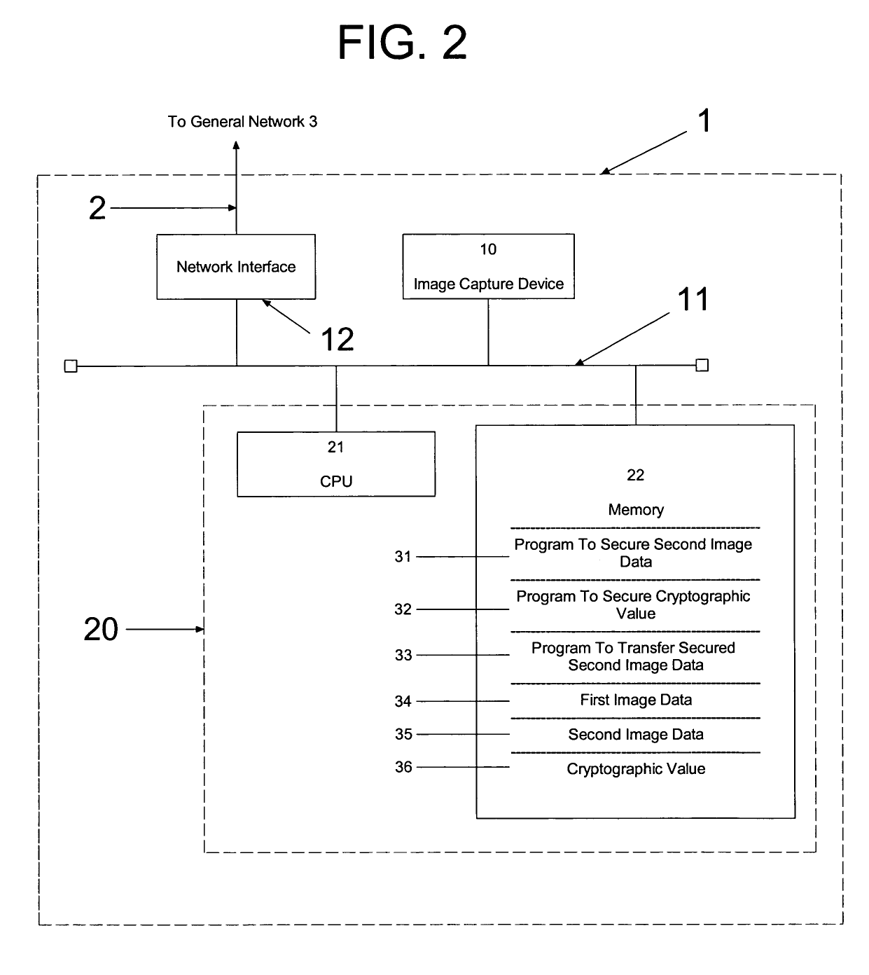

FIG. 2 provides an overview of the image input device 1, which comprises an image capture device 10 and a programmed computer 20.

The image capture device 10 may be any device that is capable of capturing image data from an object. In the present embodiment, the image capture device 10 is a scanner, but it may take other forms, such as a digital camera. The image capture device is interfaced over bus 11 to a programmed computer 20 to provide captured image data to the programmed computer 20.

The programmed computer 20 is preferably any central processing unit (CPU) 21 that is capable of executing program steps stored in a memory 22. In turn, the memory 22 stores program steps to be executed by the CPU 21, such as program 32 to derive a cryptographic value from entropy generated by capture of first image data, program 31 to a secure second image data based on the cryptographic value, and program 33 to transfer the secured image data. Memory 22 may further be configured to store the first and second image data 34 and 35, respectively, and to store the cryptographic value 36. The programmed computer 20 is interfaced through network interface 12 to the network connection 2 so that the programmed computer provides data to the network connection 2 and receives data from the network connection 2.

As shown in FIG. 1, the network connection 2 is a link from a device to a network 3, and transmits data from the device to another device through a network 3. In this manner, the network connection 2 is capable of either transmitting data received from the programmed computer 20 to another device 4 through the network 3 or receiving data transmitted from another device 4 through the network 3 to the programmed computer 20. The network connection 2 may be wired or wireless.

As explained earlier, the image capture device 10, programmed computer 20 and network interface 12 are interfaced to one another over bus 11. In this manner, the image capture device 10 is able to provide data to the programmed computer 20 and the programmed computer 20 is able to provide data to the network connection 2. However, direct connections between the image capture device 10, programmed computer 20 and network interface 12 may be used as well.

A general network 3 is an interconnected system that facilitates transmission and exchange of data from a network connection or device to another network connection or device. The Internet and local area networks (LANs) are examples of a network 3.

Generally, the other device 4 is any device that is capable of receiving data from image input device 1 over network 3, such as personal and workstation computers, network hubs, and network servers.

The certification server 5 is a computer server connected to the network 3 that holds and makes available public keys over the network 3 to any entity that requests them.

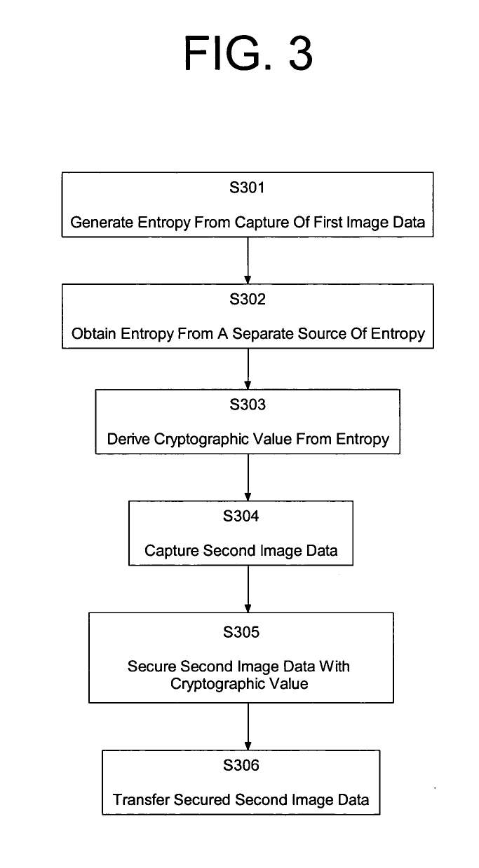

FIG. 3 is a flow chart explaining in more detail a process performed by the image input device 1 of the present invention. Briefly, according to FIG. 3, entropy is generated by capturing first image data, a cryptographic value is derived from the entropy, and second image data is secured with the cryptographic value. The secured image data is thereafter transferred to a recipient device.

In more detail, in step S301, first image data is captured with image capture device 10, thereby generating entropy. Generally, the image capture device 10 captures image data from one or more objects. If the image capture device 10 is a scanner, image capture is through the scanning of an object. If the image capture device 10 is a digital camera, image capture is through the photographic capture of an object. The objects on which the image data is based may be any article or thing so long as image data may be captured from them. For example, suitable objects for image capture include a print medium with text/graphics, a body part (e.g., a hand), a photographic picture, or (in the case of image capture with a digital camera) a natural scene.

According to a preferred embodiment of the invention, if other sources of entropy are available, other than the entropy generated by capture of the first image data 34, then the process includes a step S302, in which the programmed computer 20 obtains separate entropy from one or more of the other sources. The other sources may be any source such as entropy from the random movement or positioning of a scanning head of the image capture device 10. Additionally, the separate entropy generated in step S302 also may be from network connection data from the network connection 2. Examples of network connection data include information packet contents, rates of information packet transfer, and times between information packet transfers.

In step S303, the programmed computer 20 derives a cryptographic value based on the entropy generated from the capture of the first image data. For example, the cryptographic value may be derived through arithmetic or logical manipulation or combination of the binary data for the first image data. The cryptographic value may be an asymmetric keypair. One key, the encryption key, is used to secure or encrypt second image data whereas the other key, the decryption key, is used to decrypt the secured second image data. Alternatively, the cryptographic value may be a symmetric key.

If the process includes step S302, then in step S303, the programmed computer 20 further combines the entropy generated from the capture of the first image data 34 with the separate entropy into a combined entropy. The programmed computer 20 derives the cryptographic value 36 based on the combined entropy. For example, the cryptographic value may be a specified number of bytes derived from an arithmetic Exclusive-Or (XOR) operation of the entropy from the first image data and the entropy from the separate source.

The foregoing combination of different, separate entropies provides an even more random and unpredictable entropy than each entropy singly. This, in turn, results in an even stronger cryptographic value 36 for use in securing the second image data 35.

The cryptographic value and/or the first image data may be stored in memory 22, as shown at 36 and 34, respectively, (see FIG. 2). For example it may be preferable to store the cryptographic value so that it can be re-used to secure multiple different scans of second image data, which are described now.

In step S304, second image data that is different from the first image data is captured with the same image capture device 10 used in the capture of the first image data. The second image data may be stored in memory 22, as shown at 35.

The capture of first image data in Step S301 and that of second image data in step S304 can occur concurrently or independently. Specifically, in steps S301 and S304, the first image data 34 and second image data 35 may be captured in the same capture or different captures. In this manner, the image capture device 10 may capture the first image data 34 and second image data 35 at the same time or at different times so long as the first image data 34 and second image data 35 are different.

Likewise, the first image data 34 and second image data 35 may be captured from different objects or the same object. In the first instance, the first image data 34 is captured from one object and the second image data 35 is captured from another object. As explained above, these captures can occur in one capture of both objects at the same time or in different captures of each object one at a time. In the second instance, the first image data 34 and second image data 35 may be captured from different portions of the same object in one capture or separate captures. Alternatively, the first image data 34 and second image data 35 may be captured from the same object in different captures, but the object is moved in-between the captures so that the first image data 34 is different from the second image data 35.

In step S305, the programmed computer 20 uses the cryptographic value 36 derived in step S303 to secure the second image data 35, forming secured second image data. For example, the cryptographic value may be used to encrypt the second image data 35 from plaintext to ciphertext, or it may be used to sign or authenticate the second image data.

Once secured, step S306 transfers the secured second image data to another device through the network connection 2.

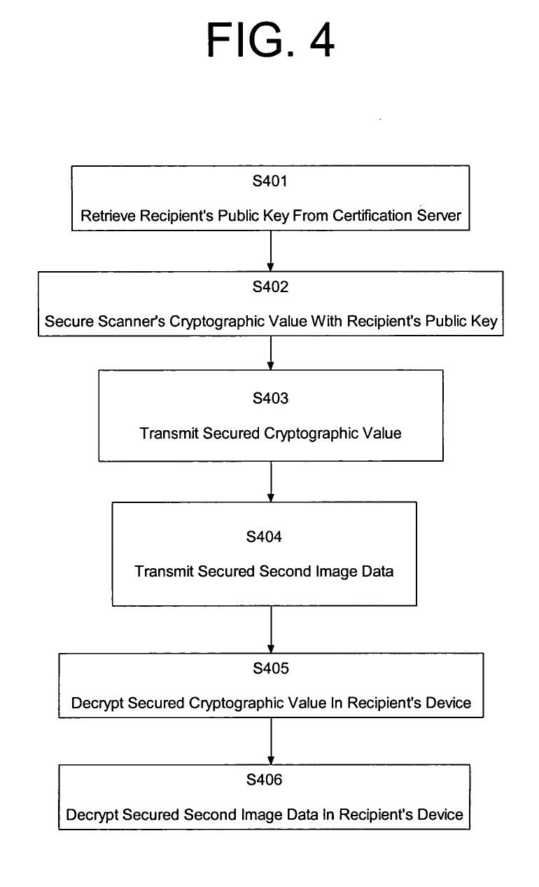

FIG. 4 illustrates the transmission of the secured second image data according to step S306. Normally, the intended recipient has already generated a public/private keypair. While maintaining the privacy of the private key, the intended recipient places the public key with certification server 5. With certification server 5, or other certification authority, any entity can retrieve the intended recipient's public key.

In step S401, the programmed computer 20 retrieves the intended recipient's public key from the certification server 5. Specifically, in response to a request by the programmed computer 20 for a recipient's public key, the certification server 5 transmits the requested public key through the network 3 to the programmed computer 20.

Once the programmed computer 20 verifies that the public key is from the intended recipient, in step S402, programmed computer 20 secures its own cryptographic value 36 generated in step S302 with the recipient's public key (step S402). If the cryptographic value used to secure the second image data is a keypair, then the decryption key is secured. If the cryptographic value is a symmetric key, then the symmetric by itself is securred.

In step S403, programmed computer 20 transmits the secured cryptographic value to the intended recipient through the general network 3. The secured cryptographic value may only be decrypted with the recipient's private key that is held by the intended recipient.

In step S404, the programmed computer 20 transmits the secured second image data over the network 3 to the intended recipient.

After the transfer of the secured second image data, a copy of the first image data 34, second image data 35, and/or the cryptographic value 36 may be stored in the memory 22 for safekeeping or reuse.

Steps S405 and S406 are performed by the recipient. In step S405, the secured cryptographic value is decrypted by the intended recipient with the recipient's private key, which is the only key that can decrypt the secured cryptographic value of image capture device 10.

Once the intended recipient receives the secured second image data, in step S406 the secured second image data is decrypted by the intended recipient with the previously-received cryptographic value 36 of the image capture device 10, to obtain the second image data 35.

According to the foregoing features, the present invention provides for the production of more random entropy from the image capture of a first image for use in securing a different second image, thereby providing more robust security for the second image.

It is to be understood that the invention is not limited to the above-described embodiments and that various changes and modifications may be made by those of ordinary skill in the art without departing from the spirit and scope of the invention.

1. A method for cryptographically securing second image data captured with an image capture device comprising the steps of:
generating entropy by capturing first image data different from the second image data;
deriving a cryptographic value based on the entropy; and
securing the second image data using the cryptographic value.

2. The method of claim 1, wherein the first image data and the second image data are acquired in separate captures.

3. The method of claim 1, wherein the first and second image data are both acquired in the same capture.

4. The method of claim 1, wherein the first and second image data each are captured from an object whose image is capable of being captured.

5. The method of claim 4, wherein the first and second image data are captured from separate objects.

6. The method of claim 4, wherein the first and second image data are captured from the same object.

7. The method of claim 6, wherein the object is moved in-between the first and second image data captures.

8. The method of claim 6, wherein the first image data is captured from one portion of the object and the second image data is captured from a separate, different portion of the object.

9. The method of claim 1, wherein the image capture device is a scanning device and the capture of the first and second image data is through scanning one or more objects.

10. The method of claim 9, wherein the scanning device is a flat bed scanner.

11. The method of claim 1, wherein the image capture device is a digital camera and the first and second image data are acquired by taking a picture of one or more objects.

12. The method of claim 1, further comprising a step of transferring the secured second image data to a recipient with a network connection.

13. The method of claim 12, wherein the transfer step comprises retrieving the recipient's public key from a certification server, securing the cryptographic value with the public key, transmitting the secured cryptographic value to the recipient, and transmitting the secured second image data to the recipient.

14. The method of claim 1, further comprising a step of obtaining a separate entropy from one or more sources other than the captured first and second image data.

15. The method of claim 14, further comprising a step of combining the separate entropy with the entropy generated from the capture of the first image data to derive the cryptographic value.

16. The method of claims 14, wherein the image capture device is a scanning device and the separate entropy is derived from random movement of a scanning head of the scanning device.

17. The method of claim 14, further comprising a step of transferring the secured second image data to another device with a network connection and the separate entropy is derived from network data from the network connection.

18. The method of claim 17, wherein the network data are information packet contents.

19. The method of claim 17, wherein the network data are rates of information packet transfer.

20. The method of claim 17, wherein the network data are times between information packet transfers.

21. The method of claim 1, further comprising the step of storing the first and second image data.

22. The method of claim 1, further comprising the step of storing the cryptographic value for re-use.

23. An apparatus for cryptographically securing second image data comprising:
an image capture device that captures first image data and second image data that is different from the first image data; and
a programmed computer that derives a cryptographic value based on entropy in the captured first image data and secures the second image data with the cryptographic value.

24. The apparatus of claim 23, wherein the image capture device is a scanning device that captures the first and second image data through scanning one or more objects.

25. The apparatus of claim 24, wherein the scanning device is a flat bed scanner.

26. The apparatus of claim 23, wherein the image capture device is a digital camera that captures the first and second image data through photographic capture of one or more objects.

27. The apparatus of claim 23, wherein the programmed computer further comprises:
a program memory for storing a data structure comprising processes for deriving a cryptographic value based on the entropy and securing the second image data with the cryptographic value; and
a processor for executing the processes.

28. The apparatus of claim 23, further comprising a network connection for transfer of the secured second image data to another apparatus or device.

29. The apparatus of claim 28, wherein the programmed computer further transfers the secured second image data to an apparatus or device of a recipient through the network connection.

30. The apparatus of claim 29, wherein the programmed computer transfers the secured second image data by retrieving an intended recipient's public key from a certification server, securing the cryptographic value with the public key, transmitting the secured cryptographic value to the recipient, and transmitting the secured second image data to the recipient.

31. The apparatus of claim 30, wherein the programmed computer further comprises:
a program memory for storing a data structure comprising processes for retrieving an intended recipient's public key from a certification server, securing a cryptographic key with the public key, transmitting the secured cryptographic value to the intended recipient, and transmitting the secured second image data to the intended recipient.

32. The apparatus of claim 23, wherein the programmed computer further obtains a separate entropy from one or more sources other than the first and second image data, combines the separate entropy with entropy in the captured first image data to form a combined entropy, and derives a cryptographic value based on the combined entropy.

33. The apparatus of claim 32, wherein the programmed computer further comprises:
a program memory for storing a data structure comprising processes for obtaining the separate entropy, combining the separate entropy with entropy in the captured first image data to form a combined entropy, deriving a cryptographic value based on the combined entropy, and securing the second image data with the cryptographic value; and
a processor for executing the processes.

34. The apparatus of claim 32, wherein the image capture device is a scanning device and the programmed computer generates the separate entropy from random movement of a scanning head of the scanning device.

35. The apparatus of claim 32, wherein the apparatus further comprises a network connection for transfer of the secured second image data to another apparatus or device and the transfer of such data generates network data, and the programmed computer generates the separate entropy from network data.

36. The apparatus of claim 35, wherein the network data are information packet contents.

37. The apparatus of claim 35, wherein the network data are rates of information packet transfer.

38. The apparatus of claim 35, wherein the network data are times between information packet transfers.

39. The apparatus of claim 23, wherein the programmed computer stores the first and second image data.

40. The apparatus of claim 39, wherein the programmed computer further comprises:
a program memory for storing a data structure comprising a process for storing the first and second image data.

41. The apparatus of claim 23, wherein the programmed computer stores the cryptographic value for re-use.

42. The apparatus of claim 41, wherein the programmed computer further comprises:
a program memory for storing a data structure comprising a process for storing the cryptographic value for re-use.

43. Computer-executable program steps stored in a computer readable medium for cryptographically securing second image data captured with an image capture device comprising the steps of:
generating entropy by capturing first image data different from the second image data;
deriving a cryptographic value based on the entropy; and
securing the second image data using the cryptographic value.

44. Computer-executable program steps according to claim 43, wherein the first image data and the second image data are acquired in separate captures.

45. Computer-executable program steps according to claim 43, wherein the first and second image data are both acquired in the same capture.

46. Computer-executable program steps according to claim 43, wherein the first and second image data are each captured from an object whose image is capable of being captured.

47. Computer-executable program steps according to claim 46, wherein the first and second image data are captured from separate objects.

48. Computer-executable program steps according to claim 46, wherein the first and second image data are captured from the same object.

49. Computer-executable program steps according to claim 48, wherein the object is moved in-between the first and second image data captures.

50. Computer-executable program steps according to claim 48, wherein the first image data is captured from one portion of the object and the second image data is captured from a separate, different portion of the object.

51. Computer-executable program steps according to claim 43, wherein the image capture device is a scanning device and the capture of the first and second image data is through scanning one or more objects.

52. Computer-executable program steps according to claim 51, wherein the scanning device is a flat bed scanner.

53. Computer-executable program steps according to claim 43, wherein the image capture device is a digital camera and the first and second image data are acquired by taking a picture of one or more objects.

54. Computer-executable program steps according to claim 43, further comprising a step of transferring the secured second image data to a recipient with a network connection.

55. Computer-executable program steps according to claim 54, wherein the transfer step comprises retrieving the intended recipient's public key from a certification server, securing the cryptographic value with the public key, transmitting the secured cryptographic value to the recipient, and transmitting the secured second image data to the recipient.

56. Computer-executable program steps according to claim 43, further comprising a step of obtaining a separate entropy from one or more sources other than the captured first and second image data.

57. Computer-executable program steps according to claim 56, further comprising a step of combining the separate entropy with the entropy generated from the capture of the first image data to derive the cryptographic value.

58. Computer-executable program steps according to claim 56, wherein the image capture device is a scanning device and the separate entropy is derived from random movement of a scanning head of the scanning device.

59. Computer-executable program steps according to claim 56, further comprising a step of transferring the secured second image data to another device with a network connection and the separate entropy is derived from network data from the network connection.

60. Computer-executable program steps according to claim 59, wherein the network data are information packet contents.

61. Computer-executable program steps according to claim 59, wherein the network data are rates of information packet transfer.

62. Computer-executable program steps according to claim 59, wherein the network data are times between information packet transfers.

63. Computer-executable program steps according to claim 43, further comprising the step of storing the first and second image data.

64. Computer-executable program steps according to claim 43, further comprising the step of storing the cryptographic value for re-use.

65. A computer readable medium which stores computer-executable process steps for cryptographically securing second image data captured with an image capture device, the computer-executable process steps comprising the steps of:
generating entropy by capturing first image data different from the second image data;
deriving a cryptographic value based on the entropy; and
securing the second image data using the cryptographic value.

66. A computer readable medium according to claim 65, wherein the first image data and the second image data are acquired in separate captures.

67. A computer readable medium according to claim 65, wherein the first and second image data are both acquired in the same capture.

68. A computer readable medium according to claim 65, wherein the first and second image data are each captured from an object whose image is capable of being captured.

69. A computer readable medium according to claim 68, wherein the first and second image data are captured from separate objects.

70. A computer readable medium according to claim 68, wherein the first and second image data are captured from the same object.

71. A computer readable medium according to claim 70, wherein the object is moved in-between the first and second image data captures.

72. A computer readable medium according to claim 70, wherein the first image data is captured from one portion of the object and the second image data is captured from a separate, different portion of the object.

73. A computer readable medium according to claim 65, wherein the image capture device is a scanning device and the capture of the first and second image data is through scanning one or more objects.

74. A computer readable medium according to claim 73, wherein the scanning device is a flat bed scanner.

75. A computer readable medium according to claim 65, wherein the image capture device is a digital camera and the first and second image data are acquired by taking a picture of one or more objects.

76. A computer readable medium according to claim 65, further comprising a step of transferring a secured second image data to a recipient with a network connection.

77. A computer readable medium according to claim 76, wherein the transfer step comprises retrieving the recipient's public key from a certification server, securing a cryptographic value with the public key, transmitting the secured cryptographic value to the recipient, and transmitting the secured second image data to the recipient.

78. A computer readable medium according to claim 65, further comprising a step of obtaining a separate entropy from one or more sources other than the captured first and second image data.

79. A computer readable medium according to claim 78, further comprising a step of combining the separate entropy with the entropy generated from the capture of the first image data to derive the cryptographic value.

80. A computer readable medium according to claim 78, wherein the image capture device is a scanning device and the separate entropy is derived from random movement of a scanning head of the scanning device.

81. A computer readable medium according to claim 78, further comprising a step of transferring the secured second image data to another device with a network connection and the separate entropy is derived from network data from the network connection.

82. A computer readable medium according to claim 81, wherein the network data are information packet contents.

83. A computer readable medium according to claim 81, wherein the network data are rates of information packet transfer.

84. A computer readable medium according to claim 81, wherein the network data are times between information packet transfers.

85. A computer readable medium according to claim 65, further comprising the step of storing the first and second image data.

86. A computer readable medium according to claim 65, further comprising the step of storing the cryptographic value for re-use.
